(19) United States
(12) Patent Application Publication
(10) Pub. No.: US 2014/0355779 A1
(43) Pub. Date: Dec. 4, 2014

(54) Multi-User Portable Audio Output Device

(71) Applicant: Michali Pusey, San Francisco, CA (US)

(72) Inventor: Michali Pusey, San Francisco, CA (US)

(21) Appl. No.: 14/263,242

(22) Filed: Apr. 28, 2014

Related U.S. Application Data
(60) Provisional application No. 61/817,026, filed on Apr. 29, 2013.

(51) Int. Cl. H04R 1/10; H04R 1/06; H04R 1/00

(52) U.S. Cl. CPC H04R 1/1041; H04R 1/00; H04R 1/06; H04R 1/1033
USPC 381/74

(57) ABSTRACT

Provided is a multi-user audio output device having multiple pairs of earphones. Several listeners may wear the earphones in order to listen to the same audio playback device. The device has a common audio cable connected to an audio jack at one end, and splits into four separate cables having earphones attached. At the junction of the audio cable split is a console. The console houses several spring-biased coiling mechanisms to enable retraction and extension of all parts of the audio cable. Additionally, several audio playback controls are disposed on the console to facilitate remote manipulation of an audio file played by a coupled audio playback device. An attachment clip is attached to the opposing side of the console and removably anchors the device to a support structure.

### CROSS REFERENCE TO RELATED APPLICATION

This application claims the benefit of U.S. Provisional Application No. 61/817,026 filed on Apr. 29, 2013, entitled “Let's Share.” The above identified patent application is herein incorporated by reference in its entirety to provide continuity of disclosure.

### BACKGROUND OF THE INVENTION

1. Field of the Invention

The present invention relates to a multi-user audio output device. More specifically, it relates to a multi-user earphone set that operatively connects to an audio playback device such as an MP3 player or smartphone. The device also provides audio playback control functionality via a set of play/pause and reverse/fast forward buttons disposed on an intermediate housing.

Music lovers often desire to share their musical selections with friends nearby. Sharing musical interests is easy when speakers are readily available. Users can play music of their choosing on an audio playback device and have the noise projected into the surrounding environment via the speakers. This setup works well for enclosed spaces, or outdoor gatherings where listeners are distributed near the speaker system. The logistics of sharing audio playback with others become more complicated when the audio enthusiasts are in a public environment, or if no large speakers are available.

Sharing music while on the go or in a public place usually involves sharing a single earpiece from a set of headphones or playing music disturbingly loud over larger speakers. The first scenario is generally irritating to the listeners, as they must stoop their heads to avoid tugging an earpiece out of the other listener's ear. The second scenario is irritating to persons around the listeners who do not wish to be disturbed by the music. Both solutions present problems for someone, whether it is the listeners or the nearby public.

Sharing earpiece style speakers also present a health hazard to participating listeners. These earpieces are usually placed at the entrance to the ear canal and are held in place by the outer portion of the wearer's ear. During normal use the earpieces can accumulate dirt and bacteria. This dirt and bacteria can then be transferred to another person's ear if another listener decides to use the earpiece. Regular sharing of earpiece speakers increases the risk of spreading harmful bacteria to healthy ears and consequently increases the risk of ear injections.

A set of earpiece style speakers is needed that accommodates multiple users. The present invention solves this problem by providing a multi-user headset that includes at least two pairs of earpieces. Users can listen to the same audio playback device without having to stretch a single pair of earpieces between them.

2. Description of the Prior Art

Devices have been disclosed in the prior art that relate to multi-user sound systems. These include devices that have been patented and published in patent application publications. These devices generally relate to systems for receiving input from or delivering output to a plurality of users. The following is a list of devices deemed most relevant to the present disclosure, which are herein described for the purposes of highlighting and differentiating the unique aspects of the present invention, and further highlighting the drawbacks existing in the prior art.

Bodley, U.S. Patent Application Publication No. 2012/0014534 discloses a wireless audio system for multiple users. The system comprises a base station in wireless communication with several microphones. Different users may select and utilize the microphones at the same time. Audio input is transmitted to the base station, where the input can be processed and sent to speakers. The system enables a multi-user panel to speak without passing a microphone between participants. This system does not provide multiple earphones connected to a single audio output jack. The present invention includes these structural elements along with additional functional features.

Other devices have disclosed single user audio output systems. Parker, U.S. Pat. No. 8,284,980 discloses a retractable earphone device. At a first end the device has a pair of earphones connected by a y-harness. The second end of the device has a connector for an audio device such as an mp3 player. The intermediate wire is trapped within a housing and wound around a spring-biased spool. The earphones may be unwound and retracted through use of short tugs on the first end of the y-shaped harness. Although the Parker device has some similarities to the present invention, it does not offer multiple sets of earphones, nor does it provide play/pause, and fast forward buttons like the present invention.

A similar device is disclosed in Boylan, U.S. Pat. No. 4,942,617. Boylan discloses a set of earphones connected to a jack via a y-shaped harness, where the harness cord is trapped within a housing. A spool disposed within the housing facilitates winding of the ear buds and jack for easy storage. The housing has a belt clip disposed on an outer surface. This belt clip can be attached to a user's pants, belt, or pockets. Unlike the present invention, Boylan does not disclose multiple sets of earphones, nor does it disclose functional buttons disposed on the housing.

Griffin, U.S. Design Pat. No. D,567,229 discloses a design for a y-shaped harness with two earphones and a volume control. This design for a device does not address the need for multiple sets of earphones or the need for control over audio advancement and playback.

These prior art devices have several known drawbacks. They do not disclose multiple sets of earphones connected to a single jack, nor do they disclose functional buttons that control audio playback on an attached audio device. It substantially diverges in design elements from the prior art and consequently it is clear that there is a need in the art for an improvement to existing multi-user audio output devices. In this regard the instant invention substantially fulfills these needs.

### SUMMARY OF THE INVENTION

In view of the foregoing disadvantages inherent in the known types of portable audio playback devices now present in the prior art, the present invention provides a new double yoke configuration wherein the same can be utilized for providing convenience for the user when sharing music between two or more listeners.

The present invention is an audio playback device configured for use by multiple listeners. The invention has an audio cable with a jack disposed at a first end and. A portion of the audio cable distal from the audio jack splits into four separate audio cables. At the end of each of the four sections of audio cable is an earphone speaker. The audio jack is plugged into the audio out port of an audio playback device such as an MP3 player or smartphone. Audio files played on the device are output through the audio port to the earphone speakers. Thus, the present invention provides an audio output device with two sets of earphone speakers.

A console is disposed at the junction of the lower portion of the audio cable and the four piece upper portion. The console is a housing that contains two spring-biased spools for storing the four lengths of audio cable associated with the earphone speakers, when not in use. On the exterior of the console are a attachment clip and a set of audio playback controls. The rear of the console has a belt clip or other clip means to enable listeners to affix the console to an anchoring structure. On the front of the console is a set of control buttons. These buttons are configured to affect changes in the status of audio playback on the audio playback device. Control buttons such as play, pause, skip, and the like, are included for user convenience.

It is therefore an object of the present invention to provide a new and improved multi-user audio playback device that has all of the advantages of the prior art and none of the disadvantages.

It is another object of the present invention to provide an audio output option that accommodates multiple listeners while maintaining a private listening experience.

Another object of the present invention is to provide an audio output device that is suitable for use by multiple listeners within a public environment.

Yet another object of the present invention is to provide an audio output device that is configured to enable control of audio playback on a coupled audio playback device.

Still another object of the present invention is to provide an audio out device that is highly portable and adapted for use in a variety of environments.

A further object of the present invention is to provide an audio output device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention with the audio controls visible. One pair of headphones is extended while another is retracted into a stowed position.

FIG. 2 shows a perspective view of the rear of the console. A belt clip protrudes from the rear surface of the console.

FIG. 3 shows a frontal view of the multi-user audio output device coupled to a smartphone.

FIG. 4 shows a perspective view of the internal components of the audio output device.

### DETAILED DESCRIPTION OF THE INVENTION

Reference is made herein to the attached drawings. Like reference numerals are used throughout the drawings to depict like or similar elements of the multi-user audio output device. For the purposes of presenting a brief and clear description of the present invention, the preferred embodiment will be discussed as used for enabling multiple listeners to enjoy audio playback in a public environment. The figures are intended for representative purposes only and should not be considered to be limiting in any respect.

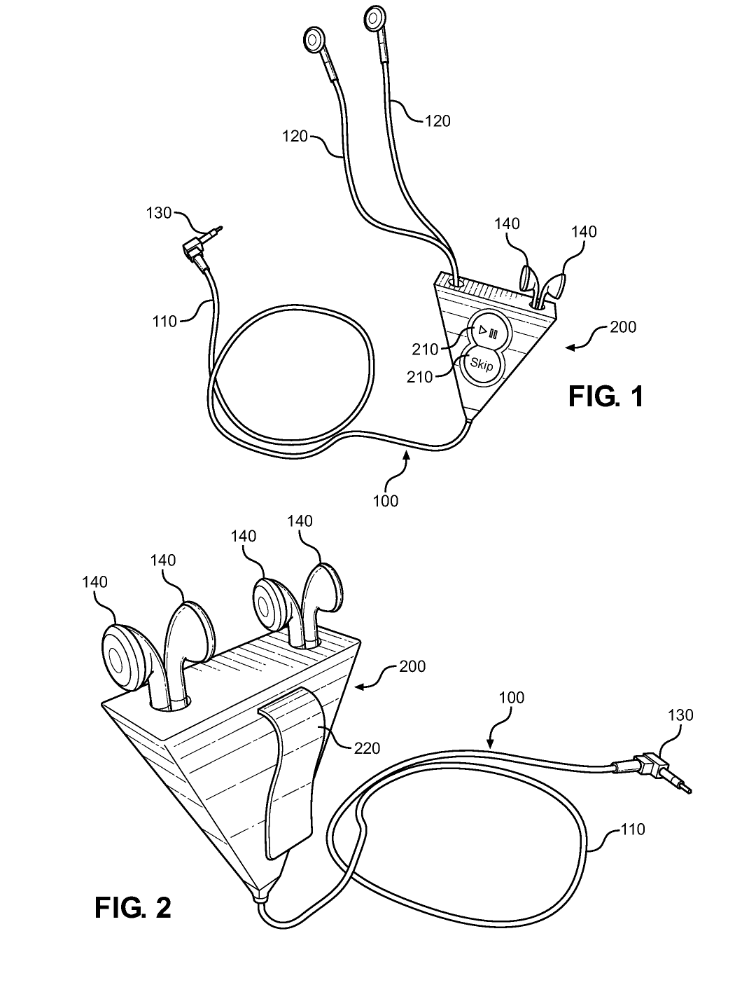

Referring now to FIG. 1, there is shown a multi-user audio output device according to the present invention. The device has a central console 200 from which an audio cable 100 extends. The console houses a plurality of sprig-biased coils, to which different portions of the audio cable are attached. Portions of the audio cable are extended and retracted via exertion of force upon the cable in a fast tugging motion. As depicted in the figure, the portions are independently retracted and extended, permitting a lower portion 110 and first pair of upper audio cables 120 are extended, while a second pair of upper portion cables are retracted into a stowed position. In both the extended and retracted state, the earphones 140 are disposed outside the console.

A set of audio playback controls 210 is disposed on a front surface of the console 200. These controls are electrically configured to provide a remote control for audio playback on the audio playback device. Control buttons may include play, pause, skip, fast-forward, reverse, shuffle, and other commonly known audio playback functions. User interaction with the control buttons initiates transmission of a wireless signal to the audio playback device. Once the signal is received and processed by the audio playback device, the desired change in audio playback status is implemented.

Turning now to FIG. 2 there is shown a view of the rear side of the console of the audio output device. The first and second pair of upper audio cable portions is retracted within the console, placing the earphones 140 in a stowed position. The spring biased coiling mechanism produces a neatly wrapped coil of audio cable, wound about a central cylinder. This stowed configuration reduces the amount of loose cable exposed outside the console, and thereby helps prevent damage to the cable. Similarly, the lower audio cable portion 110 may be retracted when not in use.

An attachment clip is disposed along the rear surface of the console. In some embodiments, the attachment clip 220 may be a belt clip, suitable for removably securing the console 200 to a user's belt. Other embodiments may include attachment clips that are loops of hook and loop fastener, buckles or the like. The attachment clip is a point of connection between the audio output device and an underlying support structure. The support structure may be an article of clothing worn on a user, an armrest, a bedpost, a car dash element or any other object capable of bearing the weight of the audio out put device. With the attachment clip firmly secured to a support structure, users are not required to continuously maintain a grip on the console during use.

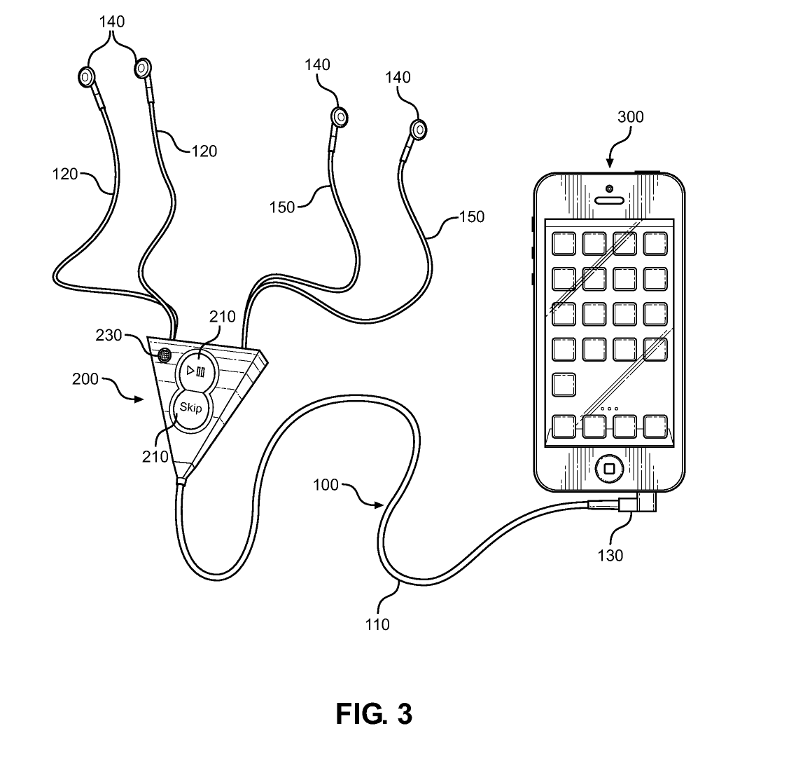

The multi-user audio output device is depicted in an in use state in FIG. 3. The first pair of upper audio cable portions 120 and second pair of upper audio cable portions 150 are extended and ready for use. Earphones 140 are disposed at the end of each upper audio cable portion. These earphones are in electrical communication with an audio jack disposed at the end of the lower audio cable portion 110. Upper and lower cable portions are part of the same audio cable, which splits from a single piece into four distinct sections. The junction or split is housed within the console 200 to reduce the risk of further separation of the lower audio cable portion. Audio output from an audio playback device 300 is transmitted via an audio port in the playback device and the audio jack 130 to the audio cable and subsequently the earphones. In this way, audio files played on a coupled audio playback device are rendered into audible noise by the audio output device. Design and construction of earphones is known in the art of portable audio output devices and hence will not be discussed herein.

Audio playback controls 210 on the front of the console 200 enable the user to manipulate the progress of audio files played on the audio playback device 300. When a user engages one of the control buttons, a circuit is completed within the integrated circuit board positioned beneath the controls. A command signal is sent by the integrated circuit to a transceiver. The command is transmitted to the coupled audio playback device, which processes the command signal and reacts accordingly. In some embodiments, the preferred transmission protocol is Bluetooth. Pairing of the audio playback device to the audio output device of the present invention may be necessary for proper functioning of the audio playback controls. Alternative configurations include general radio frequency transmissions.

A small microphone 230 may also be included in the device. Exemplary placement of the microphone is shown in FIG. 3, as an element of the console 200. The microphone is electrically connected to a transceiver, which wirelessly communicates with the connected audio playback device 300. In some embodiments, the wireless communications protocol may be a Bluetooth protocol requiring pairing of the audio output device to the audio playback device. In other embodiments, the communications may be RF or the like. Preferably, the user selects a record button on their audio playback device to initiate recording via the microphone. Alternatively, a record button may be disposed on the console to initiate and terminate audio recording. A small storage may be integrated into the electrical components of the console in order to facilitate buffering of audio signals being transmitted.

The device preferably includes an onboard battery that can be recharged via a dc power source, which connects with a power jack disposed on the console. Alternative power transfer methods such as universal serial bus may also be employed.

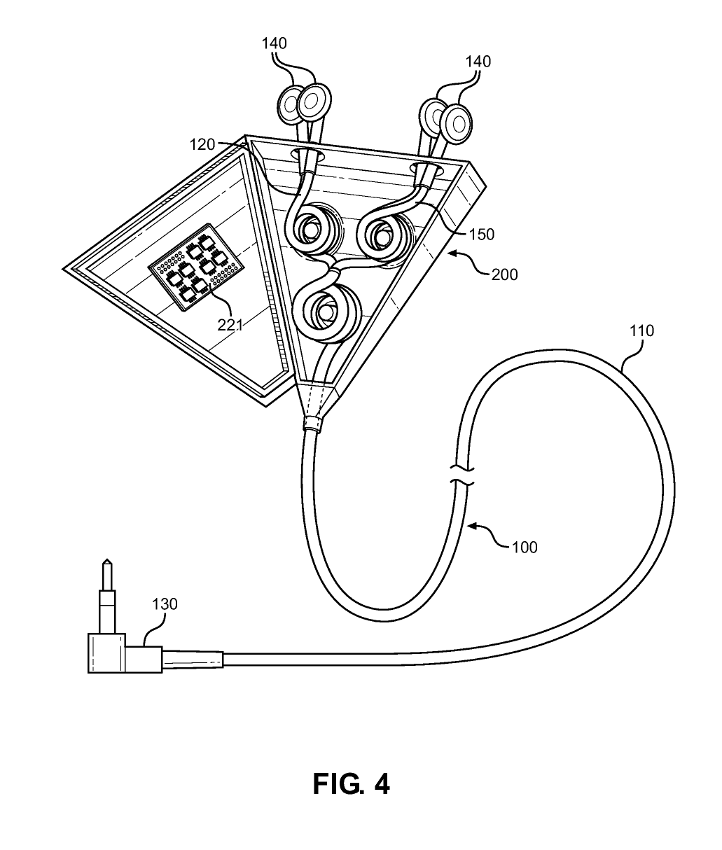

Referring finally to FIG. 4, there is shown an exposed view of the internal components of the console. One half of the console 200 interior has an integrated circuit board 221 associated with the audio playback controls (not shown). The other half of the console interior has a plurality of spring biased coiling mechanisms, seated within circular recesses. The lower audio cable portion 110 is wound around a lower coiling mechanism, which affects retraction and extension of that portion of cable. Although the majority of the lower audio cable portion is wound around the coiling mechanism or extended, a free part of the cable extends upward, toward the middle of the console.

At approximately the middle of the console, the audio cable 100 splits into four or more distinct sections. These sections form a first par of upper audio cable portions 120 and a second pair of upper audio cable portions 150. Each pair is wound around a separate spring-biased coiling mechanism. In this way, each pair of upper audio cable portions can be extended or retracted independent of the other. A yoke or bracket may be disposed at the audio cable split to reduce pulling at the junction point. Openings are disposed along the perimeter wall of the console, through which the audio cable portions extend. Size of the openings is sufficiently large for the audio cable to pass, but too small in diameter for the earphones 140 or audio jack 130. Therefore, the earphones and audio jack are maintained in an exterior disposition regardless of the state of attached audio cable.

In use, a person connects the audio jack of the present invention with the audio output port of an audio playback device. The console can then be attached to a user's belt or other support structure. Once the console is secured, the user gently tugs on a pair of earphones until they are extended. The second pair of earphones may be extended and offered to another listener. Each listener places their earphones in their ears. Audio playback can be manipulated via the audio playback controls. Users can listen to their music in any environment, without disturbing others around them.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A multi-user audio output device, comprising:
an audio cable having a single length lower portion and splitting into four or more upper portions at an intermediary point;
earphones disposed at an end of each of said upper portions;
an audio jack disposed at an end of said lower portion, wherein said audio jack is in communication with said earphones via said audio cable;
a console that houses said intermediary point;
a plurality of audio playback control buttons disposed on an outer surface of said console and configured to manipulate audio playback on a coupled audio playback device when in use;
an attachment clip secured to a surface of said console opposing said audio playback controls.

2) The device of claim 1, wherein said console houses a plurality of spring-biased coiling mechanisms configured to affect retraction and extension of upper and lower portions of said audio cable.

3) The device of claim 2, wherein a first pair of upper portions of said audio cable are retracted and extended via a first spring-biased coiling mechanism and a second pair of upper portions of said audio cable are retracted and extended via a second spring-biased coiling mechanism.

4) The device of claim 2, wherein said lower portion of said audio cable is retracted and extended via a spring-biased coiling mechanism independent from said upper portions of said audio cable.

5) The device of claim 1, wherein said attachment clip is a belt clip.

6) The device of claim 1, wherein said audio playback controls are electrically connected to an integrated circuit and wireless transceiver disposed within said console.

7) The device of claim 6, wherein command signals produced by interaction with said audio playback controls are transmitted via Bluetooth protocol.

8) The device of claim 1, further comprising:
a microphone;
a transceiver electrically and operatively coupled to said microphone.
